(19) United States
(12) Patent Application Publication
(10) Pub. No.: US 2025/0054306 A1
(43) Pub. Date: Feb. 13, 2025

(54) METHODS AND SYSTEMS FOR SHORT FORM PREVIEWS OF LONG FORM MEDIA ITEMS

(71) Applicant: Google LLC, Mountain View, CA (US)

(72) Inventors: Daniel S. Cohen, New York, NY (US); Christopher R. Conover, San Carlos, CA (US); Emily Rose Smith, Los Angeles, CA (US); Anoop Menon, Redwood City, CA (US); Benjamin Lehn, Brooklyn, NY (US); Sudheendra Vijayanarasimhan, La Canada Flintridge, CA (US); Bo Hu, Sunnyvale, CA (US); Shen Yan, Kirkland, WA (US); Xuehan Xiong, Mountain View, CA (US); David Alexander Ross, San Jose, CA (US)

(21) Appl. No.: 18/797,297

(22) Filed: Aug. 7, 2024

Related U.S. Application Data
(60) Provisional application No. 63/518,081, filed on Aug. 7, 2023.

(51) Int. Cl. G06V 20/40; G06V 10/70; H04N 21/8549

(52) U.S. Cl. CPC G06V 20/47; G06V 10/70; H04N 21/8549

(57) ABSTRACT

Aspects of the disclosure are directed to methods and systems for short form previews of long form media items. A server can provide, to an artificial intelligence (AI) model, a long form media item to be shared with users. The server can receive, from the AI model, one or more frames that are predicted to contain content that is of interest to the users. The server can extract a segment of the long form media item that corresponds to the one or more frames, where the extracted segment corresponds to a short form media item preview. The short form media item preview can be provided for presentation to the users.

### CROSS REFERENCE TO RELATED APPLICATION

This application claims the benefit of U.S. Patent Application No. 63/518,081, filed Aug. 7, 2023, which is incorporated herein in its entirety.

### TECHNICAL FIELD

Aspects and implementations of the present disclosure relate to methods and systems for short form previews of long form media items.

### BACKGROUND

A platform (e.g., a content platform) can transmit (e.g., stream) media items to client devices connected to the platform via a network. A media item can include a long form video item and/or an audio item, in some instances. Users can consume the transmitted media items via a graphical user interface (GUI) provided by the platform. In some instances, one or more content segments of a long form media item may be more interesting to a user than other content segments. For lengthy video or audio items (e.g., long movies, videos of long concerts, long lectures or long interviews, etc.), identifying segments of such a video or audio item can be challenging and time consuming.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

An aspect of the disclosure provides a computer-implemented method that includes identifying a media item to be shared with a plurality of users associated with a platform. The method further includes identifying, using an artificial intelligence (AI) model, a set of frames of the media item that include content of interest to the plurality of users. The method further includes determining, on a timeline associated with the media item, a time period that corresponds to at least one frame of the set of frames of the media item. The method further includes extracting a segment of the media item. An initial frame of the extracted segment corresponds to at least one frame of the set of frames at the determined time period and a final frame of the extracted segment corresponds to a frame at a subsequent time period on the timeline of the media item. The method further includes providing the extracted segment of the media item for presentation via a client device associated with a user of the plurality of users.

In some implementations, the AI model is trained to predict one or more frames of the media item that correspond to content of interest to the plurality of users, wherein the AI model is trained using training data identifying historic media items and comprising an indication of one or more frames of respective historic media items that are of interest to the plurality of users.

In some implementations, the media item is a long form media item comprising a music video.

In some implementations, the AI model is trained to predict one or more frames of the media item that correspond to a segment of audio associated with the music video, wherein the segment of audio is of interest to the plurality of users.

In some implementations, the AI model is trained to predict one or more frames of the media item that correspond to movement within the music video, wherein the movement is of interest to the plurality of users.

In some implementations, the extracted segment of the media item is provided for presentation as a short form music video.

In some implementations, the subsequent time period is determined according to a predefined time window.

In some implementations, the extracted segment of the media item is provided for vertical display via the client device.

In some implementations, providing the extracted segment of the media item for presentation via the client device further comprises dynamically adjusting frames of the extracted segment of the media item based on content depicted in the extracted segment of the media item.

In some implementations, dynamically adjusting the frames of the extracted segment of the media item comprises identifying one or more objects depicted in content of each frame of the extracted segment. The method further comprises determining a cropping window for each frame of the extracted segment of content, wherein the determined cropping window comprises the identified one or more objects and does not include other portions of content of a respective frame of the extracted segment of content. The method further comprises modifying each frame of the extracted segment according to a respective determined cropping window.

An aspect of the disclosure provides a system including a memory device and a processing device that is operatively coupled to the memory device. The processing device is configured to perform operations including identifying a media item to be shared with a plurality of users associated with a platform. The processing device is further configured to perform operations including identifying, using an artificial intelligence (AI) model, a set of frames of the media item that include content of interest to the plurality of users. The processing device is further configured to perform operations including determining, on a timeline associated with the media item, a time period that corresponds to at least one frame of the set of frames of the media item. The processing device is further configured to perform operations including extracting a segment of the media item, wherein an initial frame of the extracted segment corresponds to at least one frame of the set of frames at the determined time period and a final frame of the extracted segment corresponds to a frame at a subsequent time period on the timeline of the media item. The processing device is further configured to perform operations including providing the extracted segment of the media item for presentation via a client device associated with a user of the plurality of users.

An aspect of the disclosure provides a non-transitory computer-readable storage medium comprising instructions that, when executed by a processing device, cause the processing device to perform operations comprising identifying a media item to be shared with a plurality of users associated with a platform. The instructions, when executed by the processing device, cause the processing device to further perform operations comprising identifying, using an artificial intelligence (AI) model, a set of frames of the media item that include content of interest to the plurality of users. The instructions, when executed by the processing device, cause the processing device to further perform operations comprising determining, on a timeline associated with the media item, a time period that corresponds to at least one frame of the set of frames of the media item. The instructions, when executed by the processing device, cause the processing device to further perform operations comprising extracting a segment of the media item, wherein an initial frame of the extracted segment corresponds to at least one frame of the set of frames at the determined time period and a final frame of the extracted segment corresponds to a frame at a subsequent time period on the timeline of the media item. The instructions, when executed by the processing device, cause the processing device to further perform operations comprising providing the extracted segment of the media item for presentation via a client device associated with a user of the plurality of users.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 depicts an example predictive system, in accordance with implementations of the present disclosure.

FIG. 3 depicts an example artificial intelligence (AI) model for generating a short form preview of a long form media item, in accordance with implementations of the present disclosure.

FIG. 4 depicts a flow diagram of an example method for generating a short form preview of a long form media item, in accordance with implementations of the present disclosure.

FIG. 5 depicts an example user interface for presenting short form previews of a long form media item, in accordance with implementations of the present disclosure.

FIG. 6 is a block diagram illustrating an example computer system, in accordance with implementations of the present disclosure.

### DETAILED DESCRIPTION OF THE DRAWINGS

Aspects of the present disclosure generally relate to short form previews of long form media items. In conventional systems, a content platform can provide long form media items (e.g., official music videos featuring studio recordings, official music videos featuring live recordings, official music videos featuring a remix, official podcast episodes, videos provided by video owners or video uploaders, etc.) for presentation to users of the content platform. A user associated with a long form media item (e.g., an owner, uploader or viewer of the long form media item) can peruse the long form media item in order to, in some instances, find music that is new to the user or other users of the content platform, save new music to a playlist, download new music, find a segment of content that can be of interest to the user and/or other users of the content platform, etc. To do so, the user can manually search for a specific long form media item on the content platform and/or, in some instances, sample a long form media item to determine its segments that can be of interest to the particular user or multiple users. For lengthy media items (e.g., a 3-hour movie, a 2-hour concert video or audio, etc.), this can be time consuming and require significant computing resources. Furthermore, it may be difficult for an owner or uploader of a media item to accurately predict which portion of the media item can be of interest to users of the content platform. As a result, significant computing resources can be spent on generating and storing short form media items that are unlikely to be viewed or fully consumed by the users of the content platform.

Implementations of the present disclosure address the above and other deficiencies by providing methods and systems for automatically generating short form previews of long form media items. In some embodiments, a system can use artificial intelligence (AI) to perform video localization to generate the short form previews of the long form media items. Video localization refers to the identification of segments of a media item (e.g., an official music video) that depict a particular event and/or is associated with particular attributes. For purposes of explanation and illustration, an event associated with a media item, as determined by the system, can include content depicting particular actions (or types of actions) that may be of interest to a plurality of users associated with the content platform, or content having particular attributes. The particular attributes of the content can include, in some instances, a duration corresponding to (e.g., matching or approximately matching) a duration defined for short-form media items, viewing statistics indicating popularity of the content among viewers, the actions or objects that are closely related to a title, description or caption for the media item, and so forth.

In an illustrative example, upon receiving, from a user associated with a content platform, a media item to be shared with other users of the platform, the system may identify a segment of content that includes an event that is of interest to the other users of the platform. For instance, if the media item includes a music video for a song (e.g., an official music video (OMV)), the system may identify, as content of interest, one or more segments of content that are associated with a chorus of the song and/or particular attributes (e.g., a most viewed segment of the song, a segment of the song that is most replayed among users of the platform, a segment of the OMV that features choreography associated with the song, or the like). As described herein, the system can use video localization tasks to identify timestamps associated with the one or more segments of content. Using the identified timestamps, the system can extract a segment of content of the OMV to generate a short form preview of the OVM (e.g., a short form music video). In some instances, the system can generate multiple short form previews of the long form media item, where each short form preview corresponds to a different segment of content.

Video localization tasks can include moment retrieval tasks (e.g., identifying segments of a media item that correspond to an event or action of a natural language query), temporal action localization tasks (e.g., detecting a start time and/or an end time of a particular event or action and/or classifying the type of event or action taking place), action segmentation tasks (e.g., for each video frame or segment of a media item, identifying labels indicating an event or an action depicted by the video frame or segment), highlight detection tasks (e.g., identifying significant or interesting segments of a media item), and so forth.

An artificial intelligence (AI) model can be trained to perform different video localization tasks to identify a subset of frames of a long form media item for generating a short form preview of the long form media item. The AI model can receive (e.g., as input) a long form media item, such as an OVM. The OVM can be comprised of a plurality of frames. The AI model can generate a frame token for each frame of the OVM and text tokens that correspond to text within the OVM. The AI model can use the frame tokens and/or the text tokens to detect events in the OVM and to determine start and end times that correspond to the detected events. The AI model can fuse the frame and text tokens such that each frame is associated with an action label that corresponds to (e.g., describes) the content in the frame. The AI model can use the fused tokens to generate a feature pyramid that identifies the events within the OVM at different scales. The AI model can use the events in the feature pyramid to predict a subset of frames of the OVM that contain content that is of interest to the users associated with the content platform on which the short form preview is to be shared. The AI model can output the subset of frames that are predicted to contain content that is of interest to the users. In some embodiments, the AI model is trained to predict content of interest to a specific user, to a particular group of users (e.g., users from a particular geographic region, subscribers of a particular channel, paid subscribers of the content platform's service, etc.), or to users of the content platform in general.

The outputs of the AI model and a timeline associated with the OVM can be used to determine timestamps of each frame of the subset of frames. For example, using the timeline, the system can determine a timestamp associated with an initial frame of the subset of frames and a timestamp associated with a final frame of the subset of frames. The system can extract a segment of the OVM that corresponds to the subset of frames (e.g., a segment of the OVM that begins with the initial frame and ends with the final frame). In some instances, the duration of the extracted segment corresponds to a predefined time window. For example, the predefined time window can indicate that the duration of an extracted segment is, at most, 29 seconds.

For each frame of the extracted segment, the system can identify one or more objects within the frame. The system can dynamically adjust each frame to center the one or more objects depicted therein. The system can determine, for each frame, a cropping window that includes only the identified objects of the frame and excludes other content within the frame. The system can adjust each frame of the extracted segment according to the cropping window for the frame such that the identified objects are provided for presentation in the center of the frame.

Accordingly, aspects of the present disclosure provide the short form preview (e.g., the short form music video) of the long form media item for presentation to the users associated with the content platform. In some instances, the short form preview is provided for vertical presentation via user devices that stream content from the content platform. The short form preview can improve media content discovery by users of the content platform. Aspects of the present disclosure relate to a paradigm that leverages an immersive, vertical video interaction model and allows users to swipe through 29-second clips of music videos to quickly discover and collect new songs. Aspects of the present disclosure are able to algorithmically select the best 29-seconds of a video (e.g., a segment of a music video that contains content that is of interest to a plurality of users) and play only that segment for users. Aspects of the present disclosure enable users to quickly and visually experience a plurality of short form videos to find music and/or other content that is of interest to the user (e.g., music that the user likes, will listen to at full length, and/or collect for later), without requiring unnecessary consumption of computing resources that would be otherwise needed for manual identification of content of interest and/or for generation and storage of short form media items with content that was inaccurately determined to be of interest to the users of the content platform.

As used herein, a short form preview, a short form video or a short form media item refers to a media item that has a duration that falls below a particular threshold duration (e.g., as defined by a developer or administrator of a content platform).

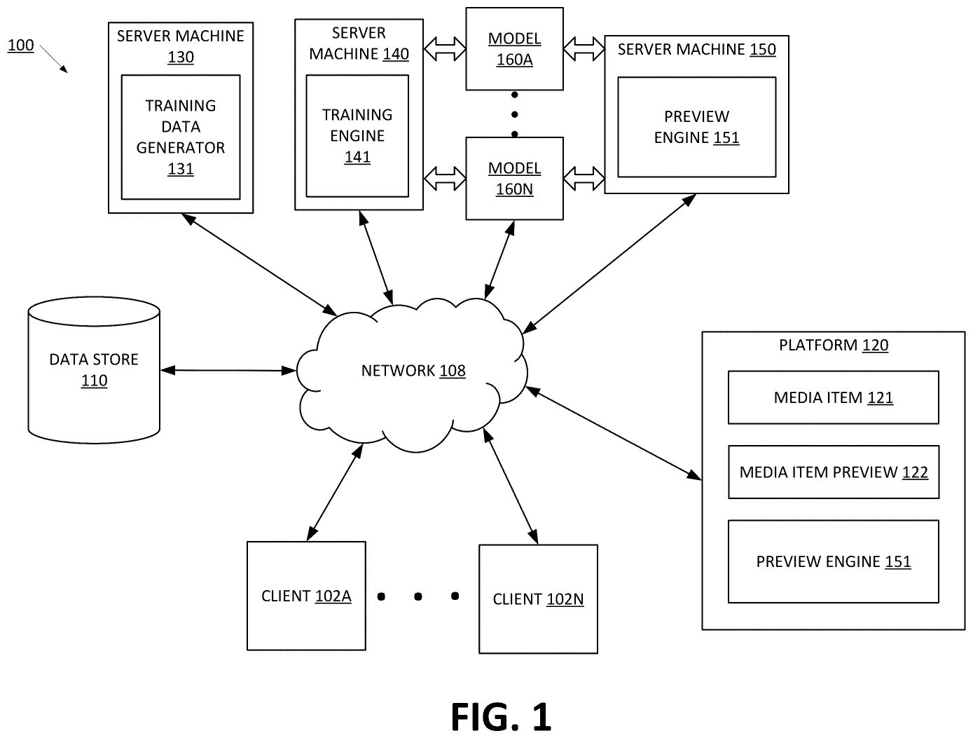

FIG. 1 illustrates an example system architecture 100, in accordance with implementations of the present disclosure. The system architecture 100 (also referred to as “system” herein) includes client devices 102A-N, a data store 110, a platform 120, and/or a server machine 150 each connected to a network 108. In some implementations, network 108 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 110 is a persistent storage that is capable of storing data as well as data structures to tag, organize, and index the data. In some embodiments, a data item can correspond to one or more portions of a document and/or a file (e.g., a media file) displayed via a graphical user interface (GUI) on a client device 102, in accordance with embodiments described herein. Data store 110 can be hosted by one or more storage devices, such as main memory, magnetic or optical storage-based disks, tapes or hard drives, NAS, SAN, and so forth. In some implementations, data store 110 can be a network-attached file server, while in other embodiments data store 110 can be some other type of persistent storage such as an object-oriented database, a relational database, and so forth, that may be hosted by platform 120 or one or more different machines coupled to the platform 120 via network 108.

The client devices 102A-N can each include computing devices such as personal computers (PCs), laptops, mobile phones, smart phones, tablet computers, netbook computers, network-connected televisions, etc. In some implementations, client devices 102A-N may also be referred to as “user devices.” Client devices 102A-N can include a content viewer. In some implementations, a content viewer can be an application that provides a user interface (UI) for users to view or upload content, such as images, video items, web pages, documents, etc. For example, the content viewer can be a web browser that can access, retrieve, present, and/or navigate content (e.g., web pages such as Hyper Text Markup Language (HTML) pages, digital media items, etc.) served by a web server. The content viewer can render, display, and/or present the content to a user. The content viewer can also include an embedded media player (e.g., a Flash® player or an HTML5 player) that is embedded in a web page (e.g., a web page that may provide information about a product sold by an online merchant). In another example, the content viewer can be a standalone application (e.g., a mobile application or app) that allows users to view digital media items (e.g., digital video items, digital images, electronic books, etc.). According to aspects of the disclosure, the content viewer can be a content platform application for users to record, edit, and/or upload content for sharing on platform 120. As such, the content viewers and/or the UI associated with the content viewer can be provided to client devices 102A-N by platform 120. In one example, the content viewers may be embedded media players that are embedded in web pages provided by the platform 120.

Platform 120 can host and/or have access to media items 121. A media item 121 can be consumed via the Internet or via a mobile device application, such as a content viewer of client devices 102A-N. In some embodiments, a media item 121 can correspond to a media file (e.g., a video file, an audio file, a video stream, an audio stream, etc.). In other or similar embodiments, a media item 121 can correspond to a portion of a media file (e.g., a portion or a chunk of a video file, an audio file, etc.). As discussed previously, a media item 121 can be requested for presentation to the user by the user of the platform 120. As used herein, “media,” media item,” “online media item,” “digital media,” “digital media item,” “content,” and “content item” can include an electronic file that can be executed or loaded using software, firmware or hardware configured to present the digital media item to an entity. As indicated above, the platform 120 can store the media items 121, or references to the media items 121, using the data store 110, in at least one implementation. In another implementation, the platform 120 can store media item 121 or fingerprints as electronic files in one or more formats using data store 110. Platform 120 can provide media item 121 to a user associated with a client device 102A-N by allowing access to media item 121 (e.g., via a content platform application), transmitting the media item 121 to the client device 102, and/or presenting or permitting presentation of the media item 121 via client device 102.

In some embodiments, media item 121 can be a video item. A video item refers to a set of sequential video frames (e.g., image frames) representing a scene in motion. For example, a series of sequential video frames can be captured continuously or later reconstructed to produce animation. Video items can be provided in various formats including, but not limited to, analog, digital, two-dimensional and three-dimensional video. Further, video items can include movies, video clips, video streams, or any set of images (e.g., animated images, non-animated images, etc.) to be displayed in sequence. In some embodiments, a video item can be stored (e.g., at data store 110) as a video file that includes a video component and an audio component. The video component can include video data that corresponds to one or more sequential video frames of the video item. The audio component can include audio data that corresponds to the video data.

Platform 120 can include multiple channels (e.g., channels A through Z). A channel can include one or more media items 121 available from a common source or media items 121 having a common topic, theme, or substance. Media item 121 can be digital content chosen by a user, digital content made available by a user, digital content uploaded by a user, digital content chosen by a content provider, digital content chosen by a broadcaster, etc. For example, a channel X can include videos Y and Z. A channel can be associated with an owner, who is a user that can perform actions on the channel. Different activities can be associated with the channel based on the owner's actions, such as the owner making digital content available on the channel, the owner selecting (e.g., liking) digital content associated with another channel, the owner commenting on digital content associated with another channel, etc. The activities associated with the channel can be collected into an activity feed for the channel. Users, other than the owner of the channel, can subscribe to one or more channels in which they are interested. The concept of “subscribing” may also be referred to as “liking,” “following,” “friending,” and so on.

In some embodiments, system 100 can include one or more third party platforms (not shown). In some embodiments, a third-party platform can provide other services associated with media item 121. For example, a third-party platform can include an advertisement platform that can provide video and/or audio advertisements. In another example, a third-party platform can be a video streaming service provider that produces a media streaming service via a communication application for users to play videos, TV shows, video clips, audio, audio clips, and/or movies, on client devices 102 via the third-party platform.

In some embodiments, a client device 102 can transmit a request to platform 120 for access to a media item 121. Platform 120 may identify the media item 121 of the request (e.g., at data store 110, etc.) and may provide access to the media item 121 via the UI of the content viewer provided by platform 120. In some embodiments, the requested media item 121 may have been generated by another client device 102 connected to platform 120. For example, client device 102A can generate a video item (e.g., via an audiovisual component, such as a camera, of client device 102A) and provide the generated video item to platform 120 (e.g., via network 108) to be accessible by other users of the platform. In other or similar embodiments, the requested media item 121 may have been generated using another device (e.g., that is separate or distinct from client device 102A) and transmitted to client device 102A (e.g., via a network, via a bus, etc.). Client device 102A can provide the video item to platform 120 (e.g., via network 108) to be accessible by other users of the platform, as described above. Another client device, such as client device 102N, can transmit the request to platform 120 (e.g., via network 108) to access the video item provided by client device 102A, in accordance with the previously provided examples.

In some embodiments, platform 120 can manage or otherwise have access to a reference media item repository, which can include one or more data stores that store media items 121 associated with platform 120. As indicated above, a media item 121 can be provided to platform 120 by an owner (e.g., a copyright holder, etc.) of the media item. In some embodiments, platform 120 can add a media item 121 to the reference media item repository in response to verifying that the user that provided the media item 121 is the media item owner (e.g., in accordance with one or more verification protocols of the platform 120). In some embodiments, data stores of the reference media item repository can be separate from data store 110. In other or similar embodiments, one or more data stores of the reference media item repository can be the same as or a part of data store 110.

As illustrated in FIG. 1, platform 120 can include a preview engine 151. Preview engine 151 can generate or otherwise obtain media item previews 122 of media items 121, according to embodiments described herein. A media item preview 122 can correspond to a segment of content of a media item 121. In some embodiments, media item preview 122 can be obtained according to embodiments described herein. Media item preview 122 can contain a segment of a media item (e.g., a 29-second segment of a music video) that contains content that is of interest to a plurality of users. Media item previews 122 can be stored in the reference media item repository and/or data store 110. In some embodiments, preview engine 151 can generate or otherwise obtain the media item preview 122 based on one or more outputs of an artificial intelligence (AI) model, such as model 160.

Training data generator 131 (i.e., residing at server machine 130) can generate training data to be used to train model 160. In some embodiments, training data generator 131 can generate the training data based on historical media items (e.g., stored at data store 110 or another data store connected to system 100 via network 104). Data store 110 (or reference media item repository 112) can store metadata associated with the training media items.

Server machine 140 may include a training engine 141. Training engine 141 can train an AI model 160A-N using the training data from training data generator 131. In some embodiments, the AI model 160A-N can refer to the model artifact that is created by the training engine 141 using the training data that includes training inputs and corresponding target outputs (correct answers for respective training inputs). For example, training inputs can identify historic media items and target outputs can indicate one or more frames of the respective historic media items that are of interest to the users. The training engine 141 can find patterns in the training data that map the training input to the target output (the answer to be predicted), and provide the AI model 160A-N that captures these patterns. The AI model 160A-N can be composed of, for example, a single level of linear or non-linear operations (e.g., a support vector machine (SVM or may be a deep network, i.e., an AI model that is composed of multiple levels of non-linear operations). An example of a deep network is a neural network with one or more hidden layers, and such an AI model can be trained by, for example, adjusting weights of a neural network in accordance with a backpropagation learning algorithm or the like. In other or similar embodiments, the AI model 160A-N can refer to the model artifact that is created by training engine 141 using training data that includes training inputs. Training engine 141 can find patterns in the training data, identify clusters of data that correspond to the identified patterns, and provide the AI model 160A-N that captures these patterns. AI model 160A-N can use one or more of support vector machine (SVM), Radial Basis Function (RBF), clustering, supervised machine learning, semi-supervised machine learning, unsupervised machine learning, k-nearest neighbor algorithm (k-NN), linear regression, random forest, neural network (e.g., artificial neural network), a boosted decision forest, etc. Further details regarding generating training data and training AI model 160 are discussed herein.

As indicated above, preview engine 151 can be configured to generate or otherwise obtain a media item preview 122 of media item 121, according to embodiments of the present disclosure. In some embodiments, preview engine 151 can provide a media item 121 as input to model 160 and can obtain one or more outputs of the model 160 that provide a prediction of a segment of content of the media item 121 that is of interest to users of platform 120. Preview engine 151 can then generate media item preview 122 based on the predicted segment, as described herein.

It should be noted that although FIG. 1 illustrates preview engine 151 as part of platform 120, in additional or alternative embodiments, preview engine 151 can reside on one or more server machines that are remote from platform 120 (e.g., server machine 150). It should be noted that in some other implementations, the functions of server machines 130, 140, 150 and/or platform 120 can be provided by a fewer number of machines. For example, in some implementations, components and/or modules of any of server machines 130, 140, 150 may be integrated into a single machine, while in other implementations components and/or modules of any of server machines 130, 140, 150 may be integrated into multiple machines. In addition, in some implementations, components and/or modules of any of server machines 130, 140, 150 may be integrated into platform 120.

In general, functions described in implementations as being performed by platform 120 and/or any of server machines 130, 140, 150 can also be performed on the client devices 102A-N in other implementations. In addition, the functionality attributed to a particular component can be performed by different or multiple components operating together. Platform 120 can also be accessed as a service provided to other systems or devices through appropriate application programming interfaces, and thus is not limited to use in websites.

Although implementations of the disclosure are discussed in terms of platform 120 and users of platform 120 accessing a media item comprising video and/or audio streams, implementations can also be generally applied to any type of media item. Implementations of the disclosure are not limited to electronic platforms that provide media item creation, editing, and/or viewing tools to users.

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.” In another example, an automated consumer can be an automated ingestion pipeline of platform 120.

Further to the descriptions above, a user may be provided with controls allowing the user to make an election as to if and/or when systems, programs, or features described herein may enable collection of user information (e.g., information about a user's social network, social actions, or activities, profession, a user's preferences, or a user's current location), and if the user is sent content or communications from a server. In addition, certain data can be treated in one or more ways before it is stored or used, so that personally identifiable information is removed. For example, a user's identity can be treated so that no personally identifiable information can be determined for the user, and/or a user's geographic location can be generalized where location information is obtained (e.g., a user's city, ZIP code, state, country, or the like), so that a particular location of a user cannot be determined. Thus, the user can have control over what information is collected about the user, how that information is used, and/or what information is provided to the user.

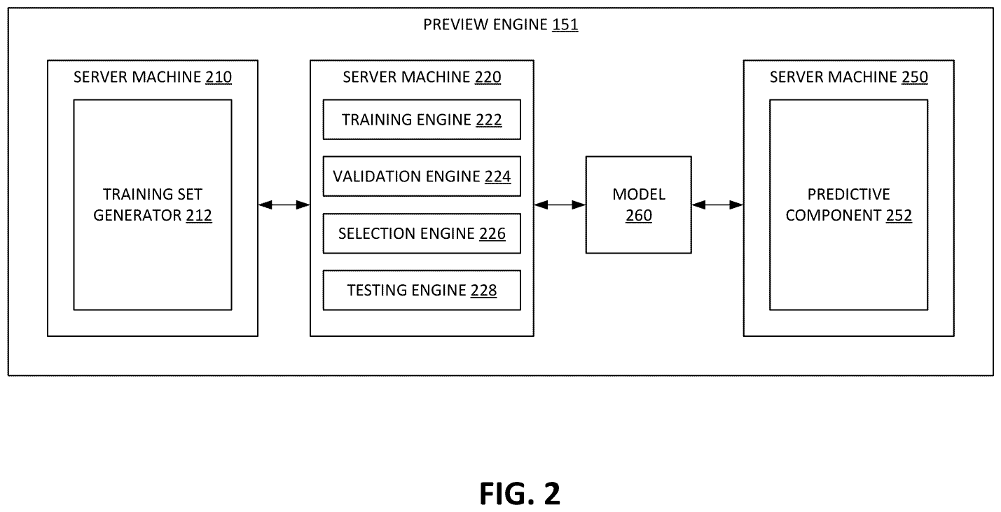

FIG. 2 illustrates an example predictive system, in accordance with implementations of the present disclosure. As illustrated in FIG. 2, preview engine 151 can include a training set generator 212 (e.g., residing at server machine 210), a training engine 222, a validation engine 224, a selection engine 226, and/or a testing engine 228 (e.g., each residing at server machine 220), and/or a predictive component 252 (e.g., residing at server machine 250). Training set generator 212 may be capable of generating training data (e.g., a set of training inputs and a set of target outputs) to train ML model 260. Model 260 can include an AI model.

As mentioned above, training set generator 212 can generate training data for training model 260. In an illustrative example, training set generator 212 can generate training data to train model 260. To do so, the training set generator 212 can initialize a training set T to null (e.g., { }). Training set generator 212 can identify data corresponding to a historical media item provided by a user of a platform (e.g., a user of platform 120 or another platform). In some embodiments, the historical media item can correspond to an official music video (OMV). Data corresponding to the historical media item may identify the historical media item and include statistics (e.g., most viewed segment, most played segment, etc.) or user provided labels indicating which portion of the historical media item is of interest to the users. For example, the training set generator 212 can identify frames of the historical media item. A frame can correspond to a segment of a video stream and/or an audio stream associated with the historical media item. The training set generator 212 can identify, from the frames and the corresponding statistics or labels, a subset of frames of the historical media item that contain content that is of interest to a plurality of users. For example, the subset of frames that contain content that is of interest to the plurality of uses can correspond to a most viewed segment of the historical media item, a most used segment of the historical media item, a segment of the historical media item that corresponds to a song's chorus, or the like.

Training set generator 212 can generate an input/output mapping. The mapping can be based on the historical media item and the subset of frames that contain content that is of interest to the plurality of users. Training set generator 212 can add the input/output mappings to the training set T and can determine whether training set T is sufficient for training the model 260. Training set T can be sufficient for training the model 260 if training set T includes a threshold amount of input/output mappings, in some embodiments. In response to determining that training set T is not sufficient for training, training set generator 212 can further analyze additional historical media items to identify corresponding frames that contain content that may be of interest to the plurality of users. In response to determining that training set T is sufficient for training, the training set generator 212 can provide training set T to model 260. In some embodiments, training set generator 212 provides the training set T to training engine 222.

Training engine 222 can train model 260 using the training data (e.g., training set T) from training set generator 212. In some embodiments, the model 260 can be an artificial intelligence (AI) model. The model 260 can refer to the model artifact that is created by the training engine 222 using the training data that includes training inputs and/or corresponding target outputs (correct answers for respective training inputs). The training engine 222 can find patterns in the training data that map the training input (the historical media item) to the target output (e.g., one or more frames that contain content that is of interest to the plurality of users). The model 260 can include one or more of decision trees, random forests, support vector machines, or other types of machine learning models. In one embodiment, such AI models may include one or more artificial neural networks (also referred to simply as a neural network). The artificial neural network can include a feature representation component with a classifier or regression layers that map features to a target output space. The artificial neural network may be, for example, a convolutional neural network (CNN) that can include a feature representation component with a classifier or regression layers that map features to a target output space, and can host multiple layers of convolutional filters. Pooling can be performed, and non-linearities may be addressed, at lower layers, on top of which a multi-layer perceptron can be commonly appended, mapping top layer features extracted by the convolutional layers to decisions (e.g., classification outputs). The neural network may further be a deep network with multiple hidden layers or a shallow network with zero or a few (e.g., 1-2) hidden layers. Deep learning may use a cascade of multiple layers of nonlinear processing units for feature extraction and transformation. Each successive layer can use the output from the previous layer as input. In deep learning, each level learns to transform its input data into a slightly more abstract and composite representation.

In some embodiments, the model 260 may include one or more recurrent neural networks (RNNs). An RNN is a type of neural network that includes a memory to enable the neural network to capture temporal dependencies. An RNN is able to learn input-output mappings that depend on both a current input and past inputs. The RNN can address past and future measurements and make predictions based on this continuous measurement information. One type of RNN that may be used is a long short term memory (LSTM) neural network.

In some embodiments, the model 260 can include at least one generative AI model, such as a large language model (LLM) allowing for the generation of new and original content. A generative AI model may include aspects of a transformer architecture, or a GAN architecture. Such a generative AI model can use other machine learning models including an encoder-decoder architecture including one or more self-attention mechanisms, and one or more feed-forward mechanisms. In some embodiments, the generative AI model can include an encoder that can encode input textual data into a vector space representation; and a decoder that can reconstruct the data from the vector space, generating outputs with increased novelty and uniqueness. The self-attention mechanism can compute the importance of phrases or words within a text data with respect to all of the text data. A generative AI model can also utilize the previously discussed deep learning techniques, including recurrent neural networks (RNNs), convolutional neural networks (CNNs), or transformer networks. A generative AI model can be pre-trained on a large corpus of data so as to process, analyze, and generate human-like text based on given input. Any of the AI models may have any typical architecture for LLMs, including one or more architectures as seen in Bidirectional Encoder Representations from Transformers (BERT), Generative Pre-trained Transformer series (Chat GPT series LLMs), or leverage a combination of transformer architecture with pre-trained data to create coherent and contextually relevant text.

Validation engine 224 can validate a trained model 260 using a corresponding set of features of a validation set from training set generator 212. The validation engine 224 can determine an accuracy of model 260 based on the corresponding sets of features of the validation set. In some embodiments, the training data can be used to train a plurality of models 260. The validation engine 224 can discard a trained model that does not meet a threshold accuracy. In some embodiments, the selection engine 226 can select a trained model that has an accuracy that meets the threshold accuracy. In some embodiments, the selection engine 226 can select the trained model that has the highest accuracy of the trained models.

The testing engine 228 can test a trained model, such as model 260, using a corresponding set of features of a testing set from training set generator 212. The testing engine 228 can test each trained model using the training set that was used to train the model. For example, a first model that was trained using a first set of features of the training set may be tested using the first set of features of the testing set. The testing engine 228 can determine a trained model that has the highest accuracy of all of the trained models based on the testing sets.

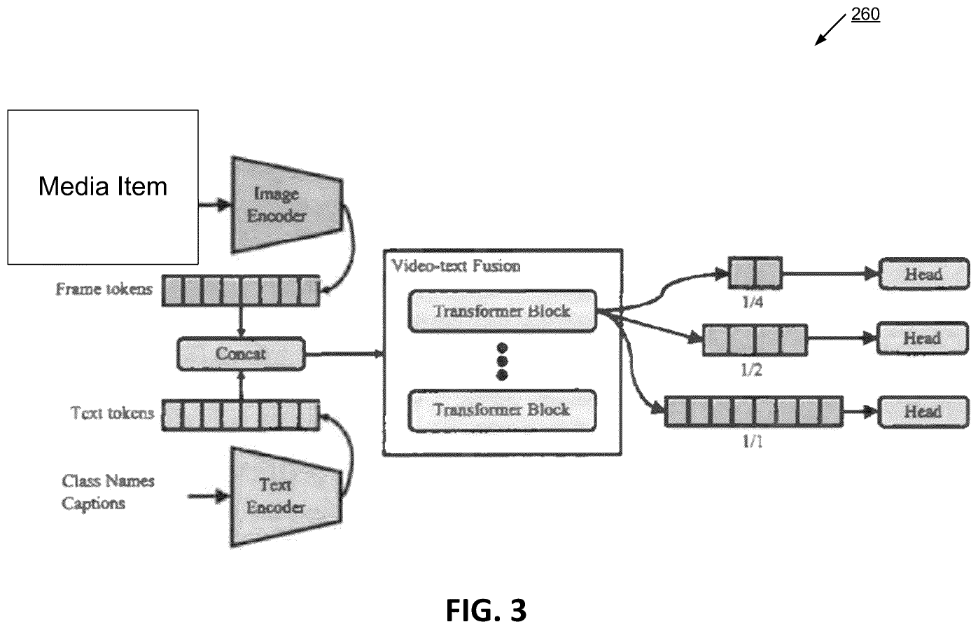

FIG. 3 depicts an example artificial intelligence (AI) model for generating a short form preview of a long form media item, in accordance with implementations of the present disclosure. As described above, the training data (e.g., training set T) can be used to train model 260 to identify a subset of frames of any media item, where the subset of frames contain content that is of interest to a plurality of users. FIG. 3 illustrates example processing (e.g., executed by the model 260) to identify the subset of frames that contain content that is of interest to the plurality of users. The identified subset of frames can be used to generate a short form preview of a long form media item, such as an official music video (OMV). An OMV can correspond to music that was released within a predetermined time frame. For example, an OMV released within the last six weeks within English speaking countries may be eligible for short form preview generation. The OMV can include a studio recording, live recording, remix, or the like.

The example processing illustrated in FIG. 3 allows model 260 to perform different video localization tasks, such as moment retrieval, temporal action localization, and action segmentation. Model 260 can use a two-tower model (e.g., with vision and text encoders), a video-text infusion module, and a feature pyramid to perform mid-level feature fusion without temporal proposals. As illustrated in FIG. 3, a media item is provided to model 260. The media item can be, for example, an OMV that includes an audio stream and/or a video stream. The model 260 can tokenize the media item. In particular, the model 260 can identify frames of the media item (e.g., frame tokens) and text that is included in the media item (e.g., text tokens). The model 260 can use the identified tokens to perform temporal action localization (TAL). The model 260 can use TAL to detect events in the media item (e.g., using video streams associated with the media item) and output start and end times that correspond to the detected events. In some instances, the media item can contain text. The model 260 can use corresponding text tokens to perform moment retrieval. For example, the model 260 can match text tokens to segments of the media item that contain actions described in a text token.

The model 260 can be configured to fuse frame and text tokens using, for example, a video-text fusion module. The model 260 can use the text and frame tokens to perform action segmentation. In particular, for each frame, the model 260 can determine an action label (e.g., a text label) that corresponds to the content in the frame. In some instances, text tokens and frame tokens can be concatenated such that information associated with text tokens are incorporated into corresponding frame tokens. In such instances, the text tokens can be removed from further processing since the information associated with the text tokens can be incorporated into information associated with corresponding frame tokens and since the text tokens might not correspond to timestamps of the media item.

The model 260 can use the frame tokens to generate a feature pyramid. The feature pyramid can be used to detect events depicted in the media item at different scales. For example, features that are associated with a top level of the feature pyramid can correspond to long-duration features and/or events of the media item. Additionally or alternatively, a bottom level of the feature pyramid can be used to identify short-duration segments of the media item. Each level of the feature pyramid can connect to a head module to predict a per-frame relevancy score and corresponding start and end times of the features associated with each level.

The model 260 can use the features identified at each level of the feature pyramid to predict one or more frames that display content that is of interest to a plurality of users. In particular, the model 260 can predict one or more frames that correspond to a segment of audio (e.g., an audio stream associated with an OMV) that is of interest to the plurality of users. Further, the model 260 can predict one or more frames that correspond to movement within the media item (e.g., a video stream associated with an OMV) that is of interest to the plurality of users. To predict the one or more frames that are of interest to the plurality of users, the model 260 can consider segments of the media item that correspond to at least one of a most played (or viewed) segment, a segment that corresponds to a song chorus, or the like.

The model 260 can output the one or more identified frames that are predicted to contain content that is of interest to the plurality of users. In some instances, a server associated with system 100 (e.g., server machine 150, which houses preview engine 151) can use the output(s) from the model 260 to identify timestamps associated with the one or more frames. The timestamps can correspond to a timeline associated with the media item. Each point on the timeline can be associated with a different frame of the media item. The server machine 150 can use the timestamps to extract the portion of the media item that corresponds to the frames that contain content that is of interest to the plurality of users. In some instances, a predefined time window is used to determine the duration of the frames that are extracted from the media item. For example, the server can identify a timestamp on the timeline that is associated with a first frame that displays content that is of interest to the plurality of users. The server can determine the duration of the segment that is extracted from the media item based on the predefined time window. For example, when the predefined time window corresponds to 29-seconds, the server can extract a 29-second segment of the media item. The extracted segment can be a short form preview of the long form media item. The server can provide the extracted segment for presentation to the plurality of users.

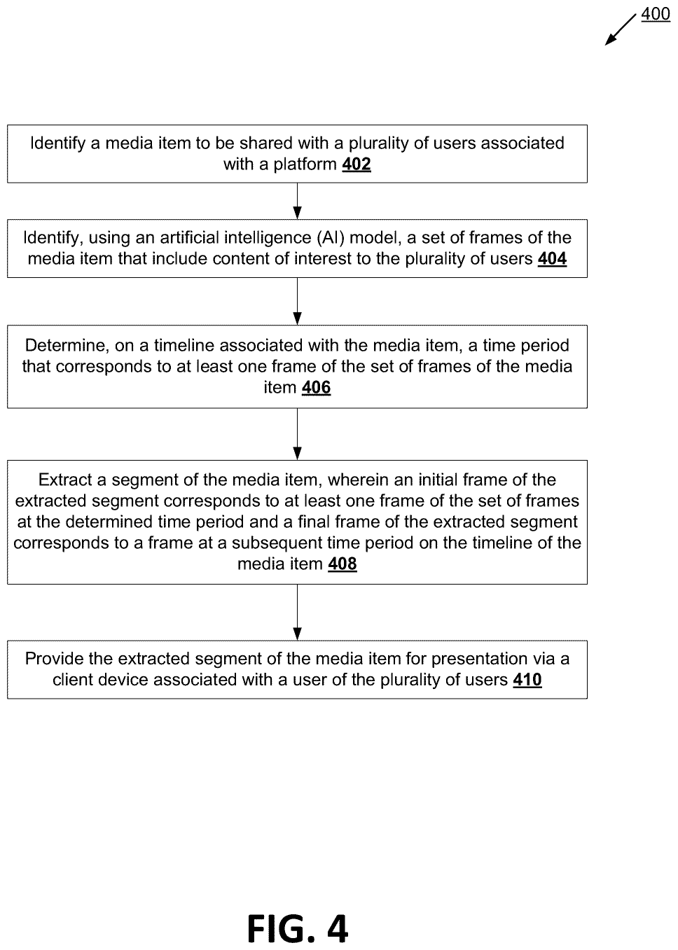

FIG. 4 depicts a flow diagram of an example method 400 for generating a short form preview of a long form media item, in accordance with implementations of the present disclosure. Method 400 can be performed by processing logic that can include hardware (e.g., circuitry, dedicated logic, etc.), software (e.g., instructions run on a processing device), or a combination thereof. In one implementation, some or all the operations of method 400 can be performed by one or more components of system 100 of FIG. 1. In some embodiments, some or all of the operations of method 400 can be performed by platform 120, server machine 150, client device 102, and/or by preview engine 151 as described herein.

At operation 402, the processing logic can identify a media item to be shared with a plurality of users associated with a platform. The media item can correspond to a long form media item, such as an official music video (OMV) that is provided to platform 120 via one or more channels (e.g., an artist channel on platform 120). The server machine 150 can provide the media item as input to an artificial intelligence model, such as model 260.

At operation 404, the processing logic can identify, using an artificial intelligence (AI) model, a set of frames of the media item that include content of interest to the plurality of users. As described in connection with FIGS. 2-3, the model 260 can be trained to predict one or more frames of any media item that contain content that is of interest to the plurality of users. In particular, the model 260 can be trained to predict the one or more frames that are of interest to the plurality of users based on historic media items and an indication of one or more frames of historic media items that contain content that is of interest to the plurality of users. This indication may include statistics associated with the historic media items and/or labels indicating content that is of interest to the users. In some instances, the model 260 can compare characteristics of a historical media item to characteristics of the media item being processed to create a media item preview to be shared with the plurality of users. When the historical media item and the media item being processed have the same or similar characteristics, the model 260 can determine the one or more frames of the media item being processed based on the one or more frames of the historical media item that are of interest to the users. The processing logic can receive one or more outputs of the model 260, where the one or more outputs correspond to the one or more frames of the media item being processed that contain content that is of interest to the plurality of users.

At operation 406, the processing logic can determine, on a timeline associated with the media item, a time period that corresponds to one or more frames of the set of frames of the media item that include content of interest to the users. The timeline can correspond to the duration of the media item. The processing logic can use the timeline associated with the media item to determine the time period that corresponds to a starting point of the one or more frames that contain content that is of interest to the plurality of users.

At operation 408, the processing logic can extract a segment of the media item such that an initial frame of the extracted segment corresponds to the frame and a final frame of the extracted segment corresponds to a frame at a subsequent time period on the timeline of the media item. The processing logic can use a timestamp associated with the initial frame and a predetermined time window to determine the duration of the extracted segment. As such, a timestamp associated with the final frame of the extracted segment can correspond to the end of the predetermined time window. The extracted segment of the media item can be a short form preview of the media item. For example, in instances where the long form media item is an OMV, the short form preview can correspond to a short form music video.

The processing logic can perform automatic cropping on the extracted segment of the media item. Automatic cropping of the extracted segment can include dynamically adjusting one or more frames of the extracted segment to center the content that is depicted in each frame of the extracted segment. In some embodiments, for each frame, the processing logic can identify one or objects depicted in the frame as well as a location within the frame of the one or more objects. The processing logic can determine a cropping window for each frame. The cropping window can correspond to a portion of the frame that includes only the one or more identified objects. The cropping window can exclude other portions of the content that is depicted in each frame. As the one or more identified objects move to different locations within frames, the processing logic can use the cropping window to maintain focus on the one or more identified objects. The processing logic can use the cropping window to modify each frame of the extracted segment such that each frame centers the one or more identified objects.

At operation 410, the processing logic can provide the extracted segment of the media item for presentation via a client device associated with a user of the plurality of users. In some instances, the extracted segment of the media item can correspond to a short form music video that is presented to the plurality of users via vertical display on a client device (e.g., client devices 102A-102N).

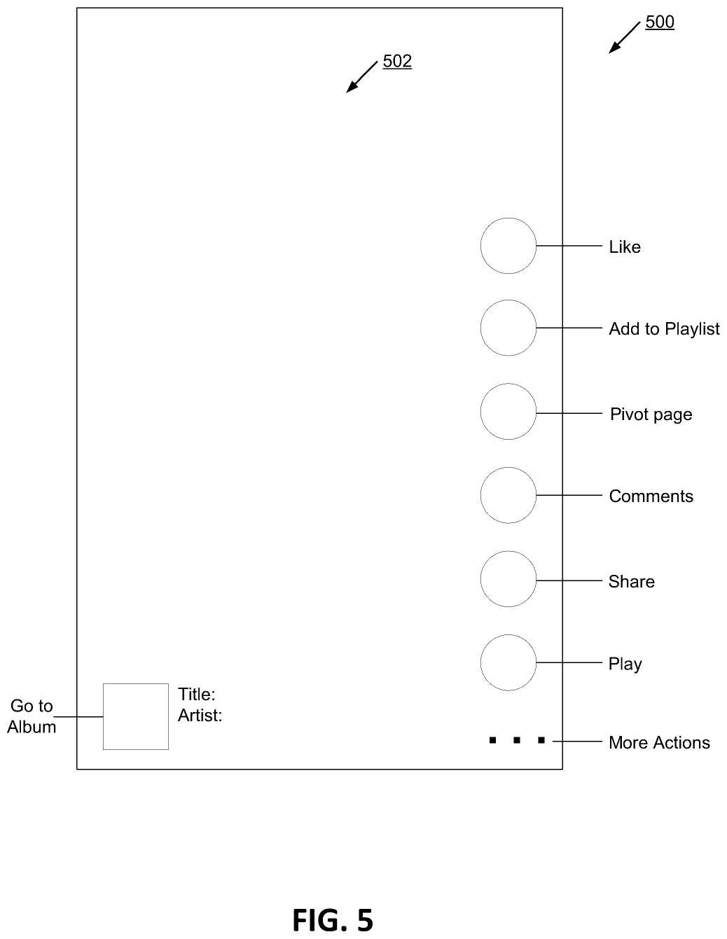

FIG. 5 depicts an example user interface (UI) for presenting short form previews of long form media items, in accordance with implementations of the present disclosure. The extracted segment of the media item (e.g., a short form media item preview) 502 can be presented for display to the plurality of users via UI 500. The short form media item preview 502 can play via UI 500 once or on a loop until, for example, a user associated with UI 500 swipes to a different short form media item preview and/or executes one or more user actions on UI 500.

As illustrated on UI 500, a user can like the short form media item preview 502 that is presented via UI 500 using, for example, a Like button. The user can save the short form media item preview 502 to a playlist using a different user button, such as an Add to Playlist button. In some instances, the user can save the short form media item preview 502 to a playlist without liking the short form media item preview 502. The user can pivot to a pivot page associated with the media item and provided via platform 120. The pivot page can present to the user content that is created using the short form media item preview 502, such as a number of short form previews associated with the long form media item. The user can comment on the short form media item preview 502 that is presented via UI 500. In some instances, the comment feature of UI 500 enables the user to draft and/or interact with comments that correspond to the long form media item. The user can share the short form media item preview 502 using, for example, a share button on the UI 500. In particular, the user can share a URL that is associated with the short form media item preview 502. The UI 500 can include a Play button that allows the user to control playback of the short form media item preview 502. In some instances, the user can perform one or more additional actions on the short form media item preview 502, such as report the short form media item preview 502, add the short form media item preview 502 to a queue, add the short form media item preview 502 to a library, or the like.

During playback of the short form media item preview 502, the UI 500 can indicate (e.g., when the short form media item preview 502 corresponds to a short form music video) a name of the song, the artist, and/or an album on which the song appears. The user can select the artist to see more songs (or media items, generally) created by the artist. In some instances, the user can select the album to see other songs on the album.

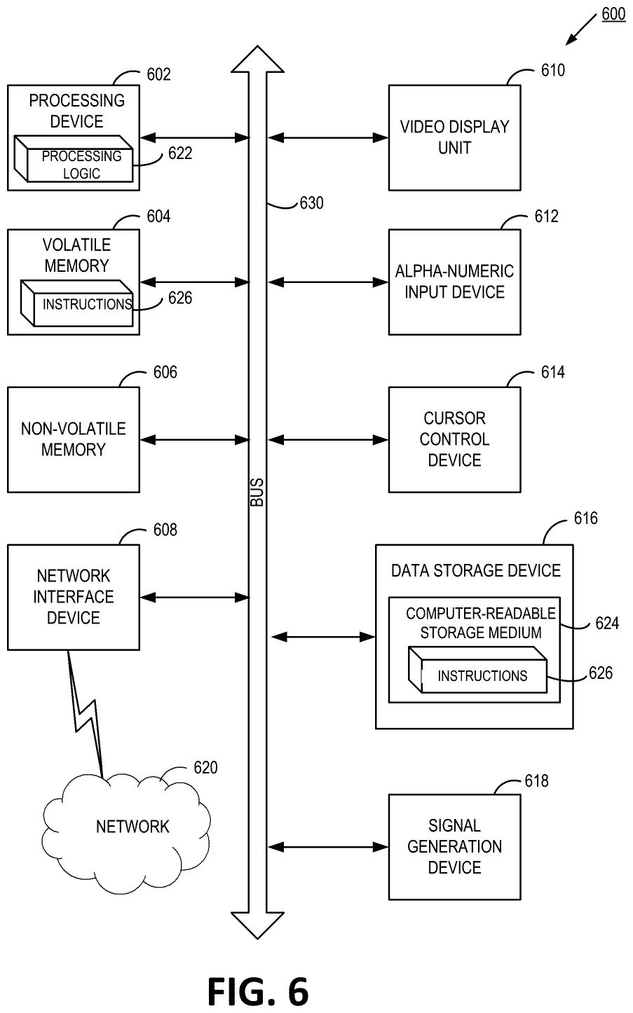

FIG. 6 is a block diagram illustrating an example computer system 600, in accordance with implementations of the present disclosure. The computer system 600 can correspond to platform 120 and/or client devices 102A-N, described with respect to FIG. 1. Computer system 600 can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processing device (processor) 602, a main memory 604 (e.g., read-only memory (ROM), flash memory, dynamic random access memory (DRAM) such as synchronous DRAM (SDRAM), double data rate (DDR SDRAM), or DRAM (RDRAM), etc.), a static memory 606 (e.g., flash memory, static random access memory (SRAM), etc.), and a data storage device 618, which communicate with each other via a bus 640.

Processor (processing device) 602 represents one or more general-purpose processing devices such as a microprocessor, central processing unit, or the like. More particularly, the processor 602 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 602 can also be one or more special-purpose processing devices such as an application specific integrated circuit (ASIC), a field programmable gate array (FPGA), a digital signal processor (DSP), network processor, or the like. The processor 602 is configured to execute instructions 405 for performing the operations discussed herein.

The computer system 600 can further include a network interface device 608. The computer system 600 also can include a video display unit 610 (e.g., a liquid crystal display (LCD) or a cathode ray tube (CRT)), an input device 612 (e.g., a keyboard, and alphanumeric keyboard, a motion sensing input device, touch screen), a cursor control device 614 (e.g., a mouse), and a signal generation device 620 (e.g., a speaker).

The data storage device 616 can include a non-transitory machine-readable storage medium 624 (also computer-readable storage medium) on which is stored one or more sets of instructions 626 embodying any one or more of the methodologies or functions described herein (instructions of preview engine 151). The instructions can also reside, completely or at least partially, within the main memory 604 and/or within the processor 602 during execution thereof by the computer system 600, the main memory 604 and the processor 602 also constituting machine-readable storage media. The instructions can further be transmitted or received over a network 630 via the network interface device 608.

In one implementation, the instructions 626 include instructions for providing fine-grained version histories of electronic documents at a platform. While the computer-readable storage medium 624 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interaction between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
identifying a media item to be shared with a plurality of users associated with a platform;
identifying, using an artificial intelligence (AI) model, a set of frames of the media item that include content of interest to the plurality of users;
determining, on a timeline associated with the media item, a time period that corresponds to at least one frame of the set of frames of the media item;
extracting a segment of the media item, wherein an initial frame of the extracted segment corresponds to at least one frame of the set of frames at the determined time period and a final frame of the extracted segment corresponds to a frame at a subsequent time period on the timeline of the media item; and
providing the extracted segment of the media item for presentation via a client device associated with a user of the plurality of users.

2. The method of claim 1, wherein the AI model is trained to predict one or more frames of the media item that correspond to content of interest to the plurality of users, wherein the AI model is trained using training data identifying historic media items and comprising an indication of one or more frames of respective historic media items that are of interest to the plurality of users.

3. The method of claim 1, wherein the media item is a long form media item comprising a music video.

4. The method of claim 3, wherein the AI model is trained to predict one or more frames of the media item that correspond to a segment of audio associated with the music video, wherein the segment of audio is of interest to the plurality of users.

5. The method of claim 3, wherein the AI model is trained to predict one or more frames of the media item that correspond to movement within the music video, wherein the movement is of interest to the plurality of users.

6. The method of claim 3, wherein the extracted segment of the media item is provided for presentation as a short form music video.

7. The method of claim 1, wherein the subsequent time period is determined according to a predefined time window.

8. The method of claim 1, wherein the extracted segment of the media item is provided for vertical display via the client device.

9. The method of claim 1, wherein providing the extracted segment of the media item for presentation via the client device further comprises dynamically adjusting frames of the extracted segment of the media item based on content depicted in the extracted segment of the media item.

10. The method of claim 9, wherein dynamically adjusting the frames of the extracted segment of the media item comprises:
identifying one or more objects depicted in content of each frame of the extracted segment;
determining a cropping window for each frame of the extracted segment of content, wherein the determined cropping window comprises the identified one or more objects and does not include other portions of content of a respective frame of the extracted segment of content; and
modifying each frame of the extracted segment according to a respective determined cropping window.

11. A system comprising:
a memory device; and
a processing device operatively coupled to the memory device and configured to perform operations comprising:
identifying a media item to be shared with a plurality of users associated with a platform;
identifying, using an artificial intelligence (AI) model, a set of frames of the media item that include content of interest to the plurality of users;
determining, on a timeline associated with the media item, a time period that corresponds to at least one frame of the set of frames of the media item;
extracting a segment of the media item, wherein an initial frame of the extracted segment corresponds to at least one frame of the set of frames at the determined time period and a final frame of the extracted segment corresponds to a frame at a subsequent time period on the timeline of the media item; and
providing the extracted segment of the media item for presentation via a client device associated with a user of the plurality of users.

12. The system of claim 11, wherein the AI model is trained to predict one or more frames of the media item that correspond to content of interest to the plurality of users, wherein the AI model is trained using training data identifying historic media items and comprising an indication of one or more frames of respective historic media items that are of interest to the plurality of users.

13. The system of claim 11, wherein the media item is a long form media item comprising a music video.

14. The system of claim 11, wherein the subsequent time period is determined according to a predefined time window.

15. The system of claim 11, wherein providing the extracted segment of the media item for presentation via the client device further comprises dynamically adjusting frames of the extracted segment of the media item based on content depicted in the extracted segment of the media item.

16. The system of claim 15, wherein dynamically adjusting the frames of the extracted segment of the media item comprises:
identifying one or more objects depicted in content of each frame of the extracted segment;
determining a cropping window for each frame of the extracted segment of content, wherein the determined cropping window comprises the identified one or more objects and does not include other portions of content of a respective frame of the extracted segment of content; and
modifying each frame of the extracted segment according to a respective determined cropping window.

17. A non-transitory computer-readable storage medium comprising instructions that, when executed by a processing device, cause the processing device to perform operations comprising:
identifying a media item to be shared with a plurality of users associated with a platform;
identifying, using an artificial intelligence (AI) model, a set of frames of the media item that include content of interest to the plurality of users;
determining, on a timeline associated with the media item, a time period that corresponds to at least one frame of the set of frames of the media item;
extracting a segment of the media item, wherein an initial frame of the extracted segment corresponds to at least one frame of the set of frames at the determined time period and a final frame of the extracted segment corresponds to a frame at a subsequent time period on the timeline of the media item; and
providing the extracted segment of the media item for presentation via a client device associated with a user of the plurality of users.

18. The non-transitory computer-readable storage medium of claim 17, wherein the subsequent time period is determined according to a predefined time window.

19. The non-transitory computer-readable storage medium of claim 17, wherein providing the extracted segment of the media item for presentation via the client device further comprises dynamically adjusting frames of the extracted segment of the media item based on content depicted in the extracted segment of the media item.

20. The non-transitory computer-readable storage medium of claim 17, wherein dynamically adjusting the frames of the extracted segment of the media item comprises:
identifying one or more objects depicted in content of each frame of the extracted segment;
determining a cropping window for each frame of the extracted segment of content, wherein the determined cropping window comprises the identified one or more objects and does not include other portions of content of a respective frame of the extracted segment of content; and
modifying each frame of the extracted segment according to a respective determined cropping window.
